(19) United States
(12) Patent Application Publication
(10) Pub. No.: US 2017/0318853 A1
(43) Pub. Date: Nov. 9, 2017

(54) COMPOSITION FOR DIETARY SUPPLEMENT

(71) Applicant: TAKABIO, Beaucouze (FR)

(72) Inventor: Charlotte FAVREAU, Beaucouze (FR)

(21) Appl. No.: 15/491,321

(22) Filed: Apr. 19, 2017

(30) Foreign Application Priority Data
May 4, 2016 (FR) 1654087

(51) Int. Cl. A23L 33/00; A23L 33/125; A23L 33/10

(52) U.S. Cl. CPC A23L 33/40; C12Y 302/01108; A23L 33/10; A23L 33/125; A23V 2002/00

(57) ABSTRACT

The invention relates to a composition of a dietary supplement comprising 3% to 8% water by weight; 14% to 20% glucose syrup; 60% to 80% sugar; 1% to 3% gelatin; 0.1% to 2% of one or more flavoring substances, and 2% to 6% fungal lactase from Aspergillus oryzae with an enzymatic activity of 100000 units per gram of enzyme. The invention also relates to a process for the preparation of the composition of a dietary supplement as well as to its preparation in the form of melting gum.

### CROSS REFERENCE TO RELATED APPLICATIONS

This application claims priority to French Patent Application No. FR1654087, filed May 4, 2016. The disclosure set forth in the referenced application is incorporated herein by reference in its entirety.

### BACKGROUND

The present invention relates to a composition for a dietary supplement comprising a fungal lactase. The invention also relates to a process for the preparation of this dietary supplement.

Today, there are a large number of products stemming from commercial milk. They are called dairy products. Dairy products are a food source that is very rich in energy. Certain dairy products are also rich in calcium and allow a good maintenance of the osseous structure of the human body. Certain enzymes of the human body are necessary for a good digestion of dairy products. This concerns in particular the lactase enzyme. In fact, lactase allows the lactose, which is a sugar contained in dairy products, to be hydrolyzed. The sugar lactose is also found in numerous other products of the agricultural food industry, including biscuits, Viennese pastries, delicatessen meats, soups, sauces as well as condiment and cooked plates. Furthermore, lactose is sometimes used as a medicinal ingredient. Therefore, the human body needs lactase for the digestion of all these products.

Lactase allows lactose (disaccharide) to be degraded by hydrolysis into galactose (monosaccharide) and glucose (monosaccharide).

Lactase is part of the family of the β-galactosidases.

Some humans are deficient in lactase. In a general manner, it is a fact that the body of the persons concerned does not produce enough lactase. The result is a (partial) inability of the body to hydrolyze the lactose to galactose and glucose. This deficiency causes painful pathologies during the digestion of dairy products. This concerns in particular pain in the gastrointestinal tract (nausea, cramps, diarrhea, etc.) after the ingestion of an edible product containing lactose. The persons concerned are therefore deemed to be intolerant to lactose. In general manner, one speaks of an “intolerance to lactose” when there is any difficulty for the metabolism to digest the lactose present in food products.

Intolerance to lactose affects a significant percentage of the human population. In certain cases, the intolerance to lactose can result in a weight loss which can have grave consequences.

The persons affected by intolerance to lactose generally try to relieve the painful symptoms in several ways. One way consists simply in avoiding dairy products and other products containing lactose. But this deprives the person of products rich in energy and calcium as well as of foods customary in daily life.

Another way is to consume dairy products without lactose. Such products are commercially available today but remain expensive on account of the previous treatment of these foods for eliminating/hydrolyzing the lactose initially present in these products.

The document WO 2008/030828 discloses a food product treated with an enzyme for the degradation of lactose.

Yet another way consists in ingesting a dietary supplement orally which comprises an effective dose of lactase. These supplements are classically present in the form of capsules, compressed tablets or powder. Lactase generally comes from a fungal source or from yeasts. However, this way remains relatively constricting, in particular on account of the aspect and of the galenics of the existing products (compressed tablets, capsules, powders). Furthermore, the dietary supplement must generally be absorbed at the same time as the consumption of the dairy product. This can alter the taste and/or the aspect of the products.

Document EP 2 120 892 discloses a composition of particles comprising lactase.

There are also dietary supplements based on lactase coming from bacteria. One method consists in ingesting bacteria which have a porous cellular membrane. The bacteria then metabolize and degrade the lactose in the bacterial cells. The ingestion of the bacteria must generally be at the same time as the consumption of the dairy product, which can alter the taste and/or the aspect of the products. Moreover, the isolation of the lactases from bacteria and the biotechnological methods for generating bacteria with a porous membrane are expensive.

Lactase is an enzyme which is unstable at ambient temperature (approximately 25° C.). In fact, lactase present in dietary supplements loses its activity so that after a certain time the supplement is no longer effective against lactose intolerance. Therefore, the products of the prior art have a rather short service life. In order to achieve the longest optimal expiration date (DLUO) (“Best Before Date”), an excess dosage of enzyme is generally made in the dietary supplements with lactase. This generates problems of industrial production (in particular expenses on account of the extra dosage) and commercialization.

### SUMMARY

The present invention intends to improve the situation.

To this end the invention introduces a composition of a dietary supplement comprising 3% to 8% water by weight; 14% to 20% glucose syrup; 60% to 80% sugar; 1% to 3% gelatin; 0.1% to 2% of one or more flavoring substances; and 2% to 6% fungal lactase from Aspergillus oryzae with an enzymatic activity of 100000 units per gram of enzyme. The composition of the invention has an increased enzymatic stability. Moreover, the composition is adapted for a regular ingestion in order to palliate the deleterious effects of an intolerance lactose.

According to an embodiment the sugar comprises 0.15% by weight powdered sugar and the rest crystallized sugar. Powdered sugar allows a good initializing of the crystallization during the process of obtaining the composition of the invention.

Furthermore, the composition of the invention can comprise 0.1% to 2% colorant. This allows a color to be given to final product, making it more attractive for consumption.

The dietary supplement is preferably made in the form of melting gum. The composition of the dietary supplement of the invention is very stable in terms of enzymatic activity at ambient temperature when it is in the form of melting gum. More precisely, the enzyme is particularly stable when the dietary supplement of the invention is made in the form of melting gum.

The invention also relates to a process for the production of dietary supplements comprising the following steps:
a. Mixing of water, glucose syrup, sugar and gelatin for obtaining a first formulation;
b. Adding fungal lactase to the first formulation of step a. for obtaining a second formulation, which fungal lactase comes from Aspergillus oryzae and has an enzymatic activity of 100000 units per gram of enzyme;
c. Adjusting the second formulation obtained in the step b. by adding sugar in order to obtain a third formulation;
d. Adding one or more flavoring substances;
e. Aerating the third formulation in a multiplier in such a manner as to form a melting gum;
f. Drying this melting gum by evaporation of part of the water; in which the quantities by weight of the water, glucose syrup, sugar, gelatin, fungal lactase and of the flavoring substance or substances in steps a. to d. are selected in such a manner as to obtain a composition of a dietary supplement after the drying of step f. comprising 3% to 8% water; 14% to 20% glucose syrup; 60% to 80% sugar; 1% to 3% gelatin; 0.1% to 2% of one or more flavoring substances; and 2% to 6% fungal lactase.

Step a. of the process for obtaining the first formulation can comprise the following sub-steps:
a1. Mixing part of the water and part of the glucose syrup at a temperature lower than or equal to 80° C.;
a2. Adding sugar to the mixture of step al. And mixing at a temperature of approximately 80° C.;
a3. Adding the remainder of the glucose syrup to the mixture of step a2. and mixing at a temperature between 80° C. and 100° C.;
a4. Mixing the gelatin with the remainder of the water at a temperature of approximately 95° C.;
a5. Adjusting the mixture obtained in step a4. to the mixture obtained in step a3. at a temperature of approximately 90° C.

This allows good conditions of homogeneity of the final product to be obtained.

The addition of the fungal lactase to step b. in order to obtain the second formulation is preferably realized at a temperature of approximately 45° C. or lower than 45° C. This allows the integrity and the activity of the enzyme to be retained. In fact, the enzyme of the invention can be unstable above 45° C.

The adjustment at step c. preferably comprises the addition of powdered sugar. As mentioned above, this allows a good initialization of the crystallization of the final product.

According to an embodiment which relates to the production of a final product with different tastes, the step d. of flavoring can be realized after the step e. of aeration. According to an embodiment which relates to the production of a final product with a single taste, the step d. of flavoring can be realized before the step e. of aeration, namely, basically in step b. of the addition of lactase. In this embodiment the step b. comprises the step d. of flavoring. The flavoring substance is therefore added in parallel with the lactase in the first formulation of the step a.; during the adjustment step c. the second formulation therefore already comprises the flavor.

The drying step f. can furthermore comprise a step f1. which consists in making the third formulation by one or several operations selected from the molding/demolding in molds of starch, the casting, the drying and the depowdering. This allows the desired aspect and appearance to be given to the dietary supplement of the invention.

Furthermore, the process of the invention can comprise a storage step which consists of storing the third formulation. The storage allows in particular the organization of the adequate commercial distribution. The storage is possible on account of the increased enzymatic stability of the composition of the invention.

### BRIEF DESCRIPTION OF THE DRAWINGS

Other advantages and characteristics of the invention will appear from a reading of the detailed description below and from the attached drawings in which:

FIG. 1 shows a flow chart for a process for fabricating the composition according to the invention;

FIG. 2 shows the effect of the pH relative to the enzymatic activity of a lactase implemented in the invention;

FIG. 3 shows the effect of the pH relative to the stability of a lactase implemented in the invention;

FIG. 4 shows the effect of the temperature relative to the enzymatic activity of a lactase implemented in the invention;

FIG. 5 shows the effect of the temperature relative to the stability of a lactase implemented in the invention; and

FIGS. 6A-B show a photograph of 6A top view and a photograph of 6B bottom view, of a dietary supplement according to the invention.

### DETAILED DESCRIPTION

The drawings and the description in the following essentially contain elements of a certain nature. They form an integral part of the description and can therefore not only serve to make the present invention better understood but can also contribute to its definition, if necessary.

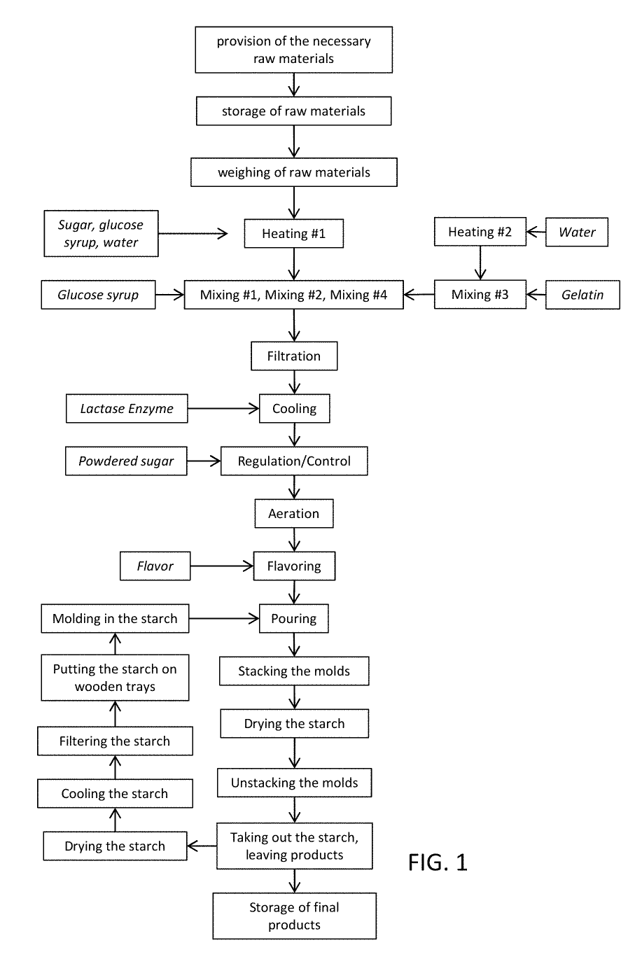

FIG. 1 shows a flow chart for the process of manufacturing a composition for a dietary supplement according to the invention.

A first operation MI.DISPO.MAT.PREM. for making available the raw materials allows the ingredients necessary for the preparation of the composition of the invention to be assembled. This concerns ingredients which constitute the final dietary supplement.

Therefore, the operation MI.DISPO.MAT.PREM. comprises the making available of water, glucose syrup, sugar, gelatin, one or more flavoring substances and fungal lactase from Aspergillus oryzae. The fungal lactase according to the present invention has an enzymatic activity of approximately 100000 units per gram of enzyme.

The operation MI.DISPO.MAT.PREM. can comprise the qualitative control of the ingredients of the composition of the dietary supplement. In this sense it concerns in particular controlling the purity and the quality of each ingredient and especially testing the desired enzymatic activity for the fungal lactase preferably fixed at 100000 units per gram of enzyme.

The first operation is followed by an operation STOCK.MAT.PREM. for storing the raw materials. The operation STOCK.MAT.PREM. comprises the storing of each ingredient under adequate conditions. The fungal lactase is advantageously stored at approximately 4° C. in order not to lose the enzymatic activity.

The operation STOCK.MAT.PREM. is generally followed by an operation PES.MAT.PREM. for weighing these ingredients (the raw materials).

The operation PES.MAT.PREM. allows in particular the selecting of a good quality for each ingredient in such a manner as to obtain the weight percentages desired for the composition for a dietary supplement.

According to the invention the quantities by weight of the water, glucose syrup, sugar, gelatin, from lactase and of the flavoring substances or substances are selected in such a manner as to obtain a composition in precise proportions. To this end it is necessary to consider that the preparation process of the invention comprises a step in which part of the water used is evaporated. Therefore, the quantities of the ingredients used in the process of the invention are selected in such a manner that the final product is a composition comprising 3% to 8% water, 14% to 20% glucose syrup, 60% to 80% sugar, 1% to 3% gelatin, 0.1% to 2% of one or more flavoring substances and 2% to 6% fungal lactase.

In one embodiment the composition of the invention is constituted by 3% to 8% water, 14% to 20% glucose syrup, 60% to 80% sugar, 1% to 3% gelatin, 0.1% to 2% of one or more flavoring substances and 2% to 6% fungal lactase.

In another embodiment the composition of the invention comprises 3.5% to 8% water, 15.3% to 20% glucose syrup, 69% to 75% sugar, 1.5% to 1.7% gelatin, 0.1% to 0.45% of one or more flavoring substances and 2.25% to 6% fungal lactase. In yet another embodiment the composition of the invention is constituted by 3.5% to 8% water, 15.3% to 20% glucose syrup, 69% to 75% sugar, 1.5% to 1.7% gelatin, 0.1% to 0.45% of one or more flavoring substances and 2.25% to 6% fungal lactase.

The operation PES.MAT.PREM. is followed by a first heating operation CHAUF.#1 in which a part of the water and a part of the glucose syrup are heated to a temperature perceptibly lower than or equal to 80° C. This operation CHAUF.#1 is followed by an operation MEL.#1 in which the part of the water and the part of the glucose syrup are mixed with sugar at a temperature perceptibly equal to 80° C. The operations CHAUF.#1 and MEL.#1 allow in particular the controlling of the homogeneity of the mixture and the consistency of the mixture. The operation MEL.#1 is followed by a second mixing operation MEL.#2 in which the remainder of the glucose syrup is added. The mixing operation MEL.#2 is performed at a temperature comprised between 80° C. and 100° C. Parallel to the operations CHAUF.#1, MEL.#1 and MEL.#2, an operation CHAUF.#2 brings part of the water to a temperature perceptibly equal to 95° C. The operation CHAUF.#2 is followed by an operation MEL.#3 in which the gelatin and the preheated water are mixed. The gelatin has a bloom force of 250 or 125. A subsequent mixing operation MEL.#4 comprises the combination of the mixture of gelatin/water and of the mixture realized by the succession of the operations CHAUF.#1, MEL.#1 and MEL.#2. The operation MEL.#4 is carried out at a temperature perceptibly equal to 90° C.

The previous operations are optionally followed by a filtering operation FILT. The filtering operation FILT. can serve as the first control point [critical control point: CCP 1]. The filtering operation allows in particular the elimination of all foreign bodies from the mixture and/or the obtention of a homogeneous mixture.

The following cooling operation REF. consists in allowing the mixture to cool down (actively or passively) and in adding the fungal lactase to the ingredients already mixed. This REF. operation ends at a temperature perceptibly equal to 45° C. This temperature allows on the one hand a good hot mixture (in particular for a good homogeneity of the mixture) and on the other hand it does not allow the lactase to denature, which is a thermosensitive enzyme. The cooling operation REF. is carried out in a cooling vat.

The REF. operation is followed by an adjustment operation REG. The REG. operation comprises the addition of sugar in the form of powdered sugar into the mixture made. This operation REF. is carried out in a buffer vat. The addition of powdered sugar allows an initializing of the crystallization of the composition of the invention. The addition of powdered sugar at a temperature of 45° C. allows the fine crystals of powdered sugar to be kept intact (the crystals do not melt at this temperature). Therefore, agglomerations of powdered sugar are avoided and therefore a final, heterogeneous product.

The REG. operation is followed by an aeration operation AIR. This AIR. operation comprises an aeration of the mixture in a multiplier. A multiplier is an apparatus which allows the mixture to multiply, that is, in particular to lighten and increase the mixture volume. The multiplier used in the aeration operation AIR. can be in particular the model B25 of MONDOMIX®.

The fact of multiplying the mixture in a situation of aeration allows the obtention of a paste which is a precursor of the composition for the dietary supplement of the invention. This precursor paste subsequently allows the obtention of a final product of melting gum. The melting gum has an aspect like meringue. The melting gum can be referred to as candy foam.

The Applicant surprisingly discovered that the composition of the invention has an increased stability of the enzymatic activity compared to the products of the prior art. In fact, the composition in the form of melting gum has a better stability over time compared, for example, to forms of the capsule or compressed tablet type.

It has not been established up to the present with certainty to what this surprising, increased stability effect is due. However, the Applicant has formulated two hypotheses. Each hypothesis is based on the fact that water (or humidity) generally destabilizes the enzymes, cf. Effects of water on enzyme performance with an emphasis on the reaction in supercritical fluids, Rezaei K., et al., Crit. Rev. Biotechnol., 2007.

The first hypothesis concerns the gelatin and the sucrose present in the composition of the invention. In fact, gelatin and sucrose are agents which suppress the activity of water. The activity of water represents the vapor pressure of water p of a moist product divided by the saturating vapor pressure p₀ at the identical temperature. Therefore, the gelatin and the sucrose have the tendency to bond to the water. This could make a screen between the water and the enzyme (reduce the amount of water available vis-a-vis the enzyme). This limitation of water could be the origin of a more stable enzymatic activity over time.

The second hypothesis concerns the secondary activity of some enzymes. In fact, some enzymes (such as some lactases) have not only a main activity of degrading lactose but also a weak secondary activity of invertase. Invertase is a degradation reaction of sucrose in glucose and fructose. This reaction consumes water. Therefore, the quantity of water is reduced and the result is an increased stability of the enzyme.

Nevertheless, none of these first and second hypotheses have been able to be verified up to the present.

Moreover, the sugar present in the composition of the invention can contribute to the stabilization of the lactase.

In any case, enzymatic stability tests have shown that the making of the composition of the invention in the form of melting gum allows an appropriate enzymatic activity to be retained over time. In this sense the enzymatic activity of the composition for a dietary supplement in the form of melting gum is greater over time compared to the known products even under identical preservation conditions.

The aeration operation AIR. is followed by an AROMA. operation which consists here in flavoring the paste obtained in the aeration operation AIR. with several flavoring substances.

A coloring operation can optionally take place before or after the aeration operation AIR. In the coloring operation one or several colorants are added to the mixture in order to obtain one or several colors of the final product.

The precursor paste obtained with the aeration operation AIR. is then dried during a drying operation SECH. The drying operation SECH. allows part of the water to be evaporated. In the embodiment described here this drying operation SECH. is accompanied by a product. Therefore, the SECH. operation is preceded by a pouring operation COUL. This pouring operation COUL. consists in pouring the precursor plate into starch molds with the aid of hoppers. The pouring operation COUL. is carried out at a temperature substantially equal to 45° C. This COUL. operation allows in particular the desired shape (for example, the shape of a sugar-coated compressed tablet) to be given to the precursor paste and therefore, subsequently, to the final product. The rows (or racks) of starch molds can then be stacked on one another in a stacking operation EMP. The EMP. stacking operation allows a second control point to be made which allows in particular the elimination of foreign bodies (for example, wood debris stemming from the transport/packaging of the ingredient, etc.).

The stacked rows or the starch molds are then subjected to the drying operation SECH., which can consist in particular in subjecting the rows/molds to a temperature lower than 40° C. (in general about 30° C.-35° C.) for one to six days. During the drying operation SECH. part of the water contained in the mixture is evaporated. The drying operation SECH. is important for obtaining the desired ponderal composition of the invention.

The drying operation SECH. is followed by a removal operation DEPI. of these rows/starch molds. This removal can be accompanied by a third control point which comprises in particular the inspection of the rows/molds (in particular for the elimination of every foreign body). The removal operation DEPI. is followed by a depowdering operation DEPOUD. The depowdering operation DEPOUD. has the effect of separating the final composition of the starch stemming from the molds. In fact, the COUL. operation comprises the pouring of the melting gum into the starch molds. When the melting gum is removed from these starch molds, a certain quantity of starch remains placed on the composition. It should be eliminated.

The starch can be treated and recycled for forming new starch molds. In the embodiment described in FIG. 1, this recycling consists of a first operation SECH.AMID. for drying starch, followed by an operation REFR.AMID. for cooling starch. The drying of the starch is generally carried out between 60° C. and 70° C. The cooling of the starch is generally carried out between 35° C. and 40° C. The starch is then filtered in an operation FILT.AMID. in order to purify it. The operation FILT.AMID. can be accompanied by a fourth control point [second critical control point: CCP 2]. The purified starch is then deposited and molded in two successive operations, respectively the operation DEPO.AMID for depositing the starch on trays and the operation MOUL.EMPR. for the molding of impressions. The recycling of the starch can be carried out several times for the production of starch molds. The recycling of the starch allows a loop to be established between the DEPOUD. operation and the COUL. operation. Therefore, the entirety of the melting gum can be put in any desired shape, for example, in the form of dietary supplements of melting gum.

A subsequent storage operation STOCK. consists in storing these dietary supplements of melting gum.

Of course, other operations of conditioning, of putting in cartons and/or of logistics can be provided after the STOCK. storing operation.

It is described here that the addition to the mixture of the flavoring substance is carried out after the cooling operation REF. and more precisely after the aeration operation AIR. In fact, this is advantageous when a plurality of tastes (by means of different flavoring substances) is provided for the final product. As a variant, when a single taste is provided for the final product, it is possible to add the desired flavor at the same moment as the addition of the lactase into the cooling vat (therefore, during the cooling operation REF). The flavoring operation is therefore carried out before the multiplying.

In a more general manner the process for the production of dietary supplements comprises the following steps:
a. Mixing of water, glucose syrup, sugar and gelatin for obtaining a first formulation;
b. Adding fungal lactase to the first formulation of step a. for obtaining a second formulation, which fungal lactase comes from Aspergillus oryzae and has an enzymatic activity of 100000 units per gram of enzyme; this step of the addition of fungal lactase is preferably carried out at a temperature lower than 45° C. in order not to degrade the enzyme;
c. Adjusting the second formulation obtained in the step b. in a buffer vat by adding sugar in order to obtain a third formulation; this step preferably comprises the addition of powdered sugar for initializing the crystallization of the final product;
d. Adding one or more flavoring substances;
e. Aerating the third formulation in a multiplier in such a manner as to form a melting gum;
f. Drying this melting gum by evaporation of part of the water; in which the quantities by weight of the water, glucose syrup, sugar, gelatin, fungal lactase and of the flavoring substance or substances in steps a. to d. are selected in such a manner as to obtain a composition of a dietary supplement after the drying of step f. comprising 3% to 8% water; 14% to 20% glucose syrup; 60% to 80% sugar; 1% to 3% gelatin; 0.1% to 2% of one or more flavoring substances; and 2% to 6% fungal lactase.

This process allows a food composition to be obtained in the form of a melting gum comprising 3% to 8% water by weight; 14% to 20% glucose syrup; 60% to 80% sugar; 1% to 3% gelatin; 0.1% to 2% of one or more flavoring substances; and 2% to 6% fungal lactase from Aspergillus oryzae with an enzymatic activity of 100000 units per gram of enzyme.

Concerning the sugar, the dietary supplement comprises 0.15% by weight powdered sugar and the rest crystallized sugar. The powdered sugar allows the initiation of the crystallization during the adjusting operation REG.

In a general manner, the step a. for obtaining the first formulation can comprise sub-steps. In particular, step a. can comprise the steps of:
a1. Mixing part of the water and part of the glucose syrup at a temperature lower than or equal to 80° C.;
a2. Adding sugar to the mixture of step a1. and mixing at a temperature of approximately 80° C.;
a3. Adding the remainder of the glucose syrup to the mixture of step a2. and mixing at a temperature between 80° C. and 100° C.;
a4. Mixing the gelatin with the remainder of the water at a temperature of approximately 95° C.;
a5. Adjusting the mixture obtained in step a4. to the mixture obtained in step a3. at a temperature of approximately 90 C.

The step d. of flavoring can be carried out after the step e. of aeration. The step d. of flavoring can also be carried out before the step e. of aeration, namely, basically at the same time as the step b. of the addition of lactase.

The drying step f. can furthermore comprise a step f1. Which consists in making the third formulation by one or several operations selected from the molding/demolding in molds of starch, the casting, the drying and the depowdering.

The process can also comprise a storage step of this third formulation.

MI.DISPO.MAT.PREM.=provision of the necessary raw materials.

STOCK.MAT.PREM.=storage of raw materials.

PES.MAT.PREM.=weighing of raw materials.

CHAUF.#1=Heating #1.

CHAUF.#2=Heating #2.

MEL.#1; MEL.#2; MEL.#4=Mixing #1, Mixing #2, Mixing#4.

MEL.#3=Mixing #3.

FILT.=Filtration.

REF.=Cooling.

REG.=Regulation/Control.

AIR.=Aeration:mixing rapidly to add air in the ingredient mix.

AROMA.=Flavoring:addition of flavor.

COUL.=the operation when the ingredient mix is put, poured in starch molds.

EMP.=to put the starch molds in a pile or stack the starch mold (see below step 4).

SECH.=Drying

DEPI.=Unstack the molds

DEPOUD.=Taking out the starch. Only the products then are left.

SECH.AMID.=Drying the starch

REFR.AMID.=Cooling the starch

FILT.AMID.=Filtering the starch

DEPO.AMID.=Putting the starch on the wooden trays

MOUL.EMPR.=Molding in the starch.

### EXAMPLES

A dietary supplement was prepared under the experimental conditions previously described (cf. process indicating the mixture sequences and the temperatures). A mixture was carried out with the following ingredients and quantities (% by weight):
Water: 15.96%;
Glucose syrup: 15.1%;
Sugar (crystallized sugar and powdered sugar): 63.0%;
Gelatin: 1.40%;
Flavor: 0.34%;
Fungal lactase: 4.20%;

The glucose syrup can be the Glucor 68-80 HM of Chamtor of the VIVESCIA group®. The crystallized sugar comes from the company BRITISH SUGAR PLC. And the powdered sugar comes from the company ISCAL SUGAR. The gelatin comes from the company ITALGELATINE S.p.A. under the product reference 250AH30. The gelatin has a bloom force of 250 or 125.

The fungal lactase used comes from Aspergillus oryzae and has an enzymatic activity of 100000 units per gram of enzyme. The lactase can be obtained from the SHIN NIHON CHEMICAL under the product reference SUMIZYME® FUNGAL LACTASE 100000 u/g (or Sumizyme GLL or Sumizyme FUNGAL LACTASE-SD).

The lactase is a β-Galactosidase (bêta-galactosidase) whose EC number is: EC 3.2.1.23. This EC number is defined in the classification of enzymes established by the international union of biochemistry and of molecular biology (IUBMB: International Union of Biochemistry and Molecular Biology). The lactase is present in the form of a fine dry powder with a whitish color. The lactase has no odor and is soluble in water. This allows adequate predispositions for the preparation of the dietary supplement.

The lactase used has a β-galactosidase activity for converting the lactose into galactose and glucose. The enzymatic activity test results in: FCC 100000 u/g (Food Chemicals Codex). This test is based on a hydrolysis for 15 minutes of a substrate o-nitrophenyl-β-D-galactopyranoside at a temperature of 37° C. and a pH of 4.5. This test is in conformity with the regulations of the FCC IV, cf. Fourth Edition of the Food Chemicals Codex, Committee on Food Chemicals Codex, Food and nutrition board, Institute of Medicine, National Academy of Sciences, 1996.

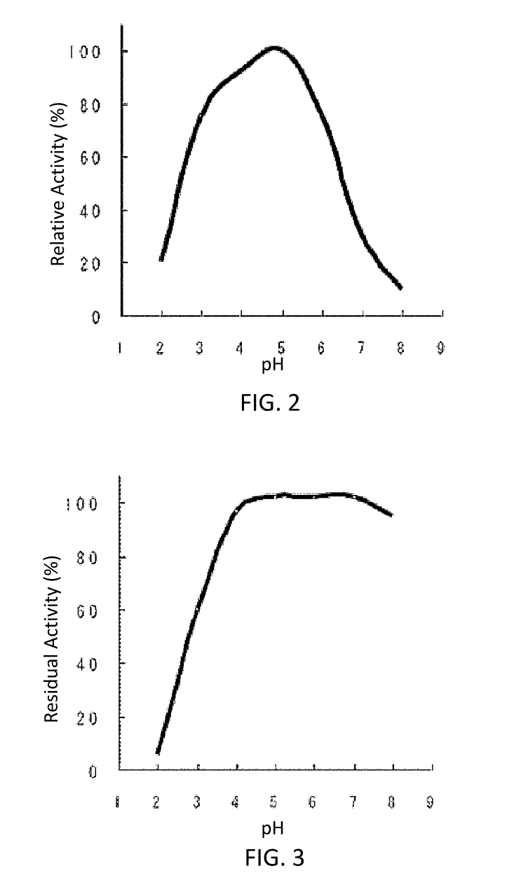

FIG. 2 shows the effect of the pH relative to the enzymatic activity of lactase. The reaction temperature is 37° C. the reaction time is 10 minutes. The optimum pH is about pH=4.5.

FIG. 3 shows the effect of the pH on the stability of lactase. The enzymatic concentration is 1%. The reaction temperature is 37° C. The incubation time is 1 hour. Lactase has a good stability for a pH comprised between pH=4.5 and pH=8.

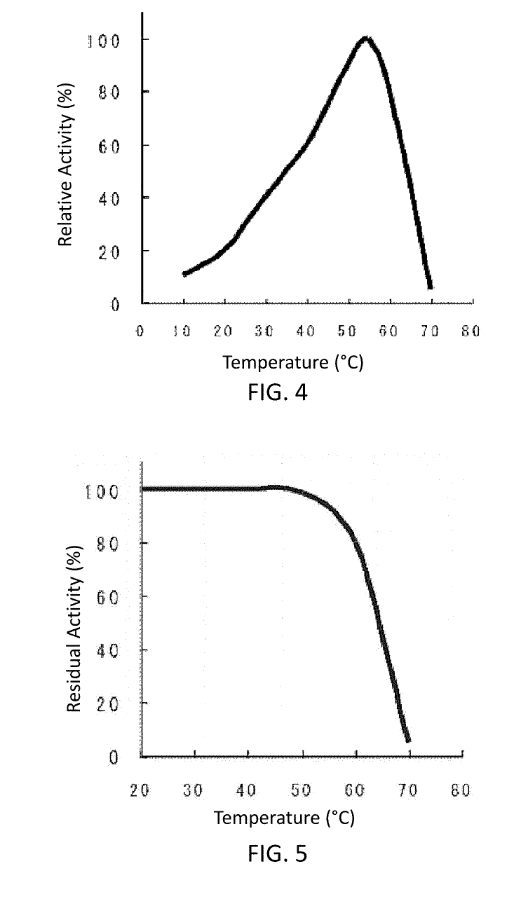

FIG. 4 shows the effect of the temperature on the enzymatic activity of lactase. The pH of the reaction is pH=4.5 The reaction time is 10 minutes. The optimum temperature is approximately 50° C.

FIG. 5 shows the effect of the temperature on the stability of lactase. The enzymatic concentration is 1%. The incubation time is 30 minutes. Lactase is stable up to a temperature of approximately 50° C. The inactivation of lactase can be obtained by subjecting the enzyme to a temperature of approximately 80° C. for 15 min.

In the present example the addition of fungal lactase is made at a temperature of 45° C. This ensures a good activity and stability of the enzyme.

The water is evaporated by drying at a temperature between 20 and 40° C. for a time of 24 h to 6 days in molds made of starch.

After the evaporation of part of the water the mixture has the following quantities of ingredients (% by weight).
Water: 4.98%;
Glucose syrup: 17.1%;
Sugar (crystallized sugar and powdered sugar): 71.2%;
Gelatin: 1.58%;
Flavor: 0.39%;
Fungal lactase: 4.75%;

The starch molds used during the drying operations allow the obtention of a final product in the form of substantially round lozenges (sugar-coated compressed tablets). The diameter of a lozenge is substantially comprised between 15 and 25 mm, preferably approximately 20 mm. The weight of a lozenge is substantially comprised between 1.0 g and 1.5 g, preferably approximately 1.3 g.

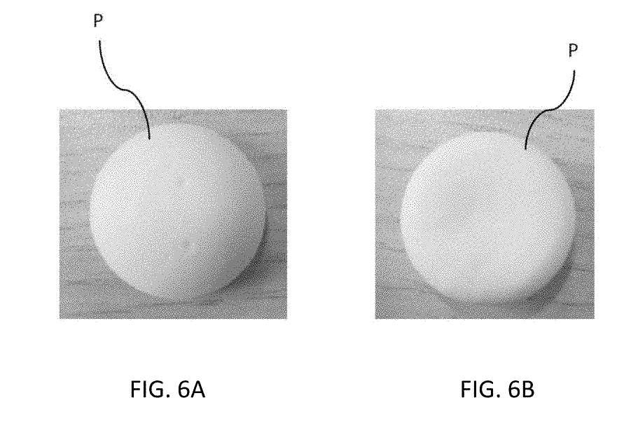

FIGS. 6A-B shows a lozenge P of melting gum according to the present embodiment with the composition of the invention. The left side of FIG. 6A shows a top view of the lozenge P and the right side of FIG. 6B shows a bottom view of the lozenge P.

The melting gum lozenges of the invention were compared with lactase products in the form of compressed tablets and capsules.

Each comparative lactase product comprises the same lactase as the composition of the invention, namely, here the SUMIZYME FUNGAL LACTASE at 100000 u/g. The lactase compressed tablets were made by a classic technique for making compressed tablets (mixture of the necessary ingredients followed by a compression by a compressor). The result is a compressed tablet with an oblong shape (13×8.7 mm) of approximately 450 mg. The composition of the compressed tablet is as follows: maltodextrin; lactase 100000 FCC/g; dextrose; microcrystalline cellulose (charging agent) and magnesium stearate (anti-agglomerating agent).

The lactase capsules were made by a classic technique of placing the following mixture of ingredients in a capsule (capsule-filling machine): maltodextrin and lactase 100000 FCC/g. The capsules used were vegetable capsules (HPMC) of size 1, transparent and with a target filling weight of 250 mg.

Each product was objected to a test for enzymatic activity. The test also takes into account measures of enzymatic activity carried out on a check sample, namely, raw fungal lactase (from Aspergillus oryzae and has an enzymatic activity of 100000 units per gram of enzyme. The products (including the check sample) were packaged separately in respective food bags (non-hermetic) then placed in an autoclave at 25° C./60% HR (relative humidity). The test comprised several measures of enzymatic activity, namely, a measuring at 2 months, at 4 months and at 6 months. The measures of activity were performed according to the same method as before (SNC method). The results are shown in table 1 below.

TABLE 1
Percentage of residual enzymatic activity per gram of product (g) as
a function of time.

| | At₀ (%): | At₁ (%): | At₂ (%): | At₃ (%): |
|---|---|---|---|---|
| | Initial | Activity after | Activity after | Activity after |
| Product | activity | 2 months | 4 months | 6 months |
| Lactase | 100 | 83.6%; | 69.4%; | 66.4%; |
| capsules | | | | |
| Lactase | 100 | 86.0%; | 73.4%; | 67.9%; |
| compressed | | | | |
| tablets | | | | |
| Check sample | 100 | 93.7%; | 68.0%; | 61.6%; |
| Lozenge | 100 | 93.5%; | 92.0%; | 83.9%; |
| (invention) | | | | |

The comparative test shows that the composition of the invention made in the form a melting gum has a stability well above comparative products (capsules and compressed tablets).

The stability of the enzymatic activity of the lactase contained in the final product has advantages. In particular, the stability in time of the composition of the invention offers late DLUO [optimal expiration dates] of the final products, which is very interesting in terms of industrialization and of commercialization. As a result of the high stability of the composition of the invention, a lesser quantity of lactase is necessary for obtaining identical DLUOs compared to existing dietary supplements of lactase. There is no need to palliate the loss of enzymatic activity by an excess dosage of lactase.

The embodiment was prepared in the form of lozenges. Other embodiments are conceivable. In particular, there is a great variability of forms of the final products. Therefore, the dietary supplement of melting gum can be, for example, in the form of pearls or of any other attractive form for consummation (such as the forms of animals for a supplement intended for children).

Another embodiment in the form of lozenges of melting gum was made with the ingredients with the following quantities (% by weight):
Water: 14.75%;
Glucose syrup: 13.82%;
Sugar (crystallized sugar and powdered sugar): 65.42%;
Gelatin: 1.44%;
Flavor: 0.35%;
Fungal lactase: 4.22%;

The above concerns quantities before the operation or operations of the evaporation of the water. After the operation or operations of the evaporation of the water, the composition of the final product has the following quantities (% by weight):
Water: 5.15%;
Glucose syrup: 15.37%;
Sugar (crystallized sugar and powdered sugar): 72.79%;
Gelatin: 1.61%;
Flavor: 0.38%;
Fungal lactase: 4.7%;

Other embodiments corresponding to the characteristics of the invention were used. More particularly, mixtures were made with the following ingredients and quantities (% by weight):
Water: 14.0% to 16.5%;
Glucose syrup: 13.5% to 15.5%;
Sugar (crystallized sugar and powdered sugar): 62.5% to 65.5%;
Gelatin: 1% to 1.45%;
Flavor: 0.08% to 0.4%;
Fungal lactase: 2.1% to 5%;

The above concerns quantities before the operation or operations of the evaporation of the water. After the operation or operations of the evaporation of the water, the composition of the final product has the following quantities (% by weight):
Water: 3.5% to 8%;
Glucose syrup: 15.3% to 20%;
Sugar (crystallized sugar and powdered sugar): 69% to 75%;
Gelatin: 1.5% to 1.7%;
Flavor: 0.1% to 0.45%;
Fungal lactase: 2.25% to 6%;

Optionally, each mixture can comprise a colorant to make the aspect of the final product more attractive. The mixture before the evaporation of water can contain in particular from 0.1% to 1.5% of colorant. The final product after evaporation can comprise 0.1% to 2% colorant. It is then appropriate to remove a corresponding quantity of water.

The present invention allows a lactase activity to be retained for a long time in a dietary supplement. In fact, the lactase present in the composition of the invention does not degrade or hardly degrades for several months at ambient temperature (for a period more than six months). The problems of industrial production and of commercialization concerning the DLUO (optimal expiration date) and/or of excessive overdose have been solved.

Furthermore the aspect in the form of melting gum of the composition of the invention is very agreeable for ingesting. The flavors of the composition impart a semblance of a consumable sweetmeat to the melting gum. The dietary supplement of the invention is therefore suitable for being consumed before, after or during meals during a day. This allows persons with lactose intolerance to regularly ingest an efficacious dose of lactose. Dairy products and other products containing lactose can therefore be normally consumed. Therefore, the dietary supplement of the invention is an effective means for combating lactose intolerance.

1. Composition of dietary supplement comprising by weight:
3% to 8% water;
14% to 20% glucose syrup;
60% to 80% sugar;
1% to 3% gelatin;
0.1% to 2% of one or more flavoring substances;
2% to 6% fungal lactase from Aspergillus oryzae, the lactase having an enzymatic activity of 100000 units per gram of enzyme.

2. Composition according to claim 1, in which the sugar comprises 0.15% by weight powdered sugar and the rest crystallized sugar.

3. Composition according to claim 1 further comprising 0.1% to 2% colorant.

4. The composition according to claim 1 made in the form of melting gum, also designated a lozenge.

5. Process for the production of a dietary supplement comprising the following steps:
a. Mixing water, glucose syrup, sugar and gelatin for obtaining a first formulation;
b. Adding fungal lactase to the first formulation for obtaining a second formulation, which fungal lactase comes from Aspergillus oryzae, the lactase having an enzymatic activity of 100000 units per gram of enzyme;
c. Adjusting the second formulation in a buffer vat by adding sugar in order to obtain a third formulation;
d. Adding one or more flavoring substances;
e. Aerating the third formulation in a multiplier in such a manner as to form a melting gum;
f. Drying the melting gum by evaporation of part of the water; in which the quantities by weight of the water, glucose syrup, sugar, gelatin, fungal lactase and the flavoring substance or substances in steps a. to d. are selected in such a manner as to obtain a composition of a dietary supplement after the drying of step f. comprising 3% to 8% water; 14% to 20% glucose syrup; 60% to 80% sugar; 1% to 3% gelatin; 0.1% to 2% of one or more flavoring substances, and 2% to 6% fungal lactase.

6. The process according to claim 5, in which step a. comprises the sub-steps of:
a1. Mixing part of the water and part of the glucose syrup at a temperature lower than or equal to 80° C.;
a2. Adding sugar to the mixture of step a1. and mixing at a temperature of approximately 80° C.;
a3. Adding the remainder of the glucose syrup to the mixture of step a2. and mixing at a temperature between 80° C. and 100° C.;
a4. Mixing the gelatin with the remainder of the water at a temperature of approximately 95° C.;
a5. Adjusting the mixture obtained in step a4. to the mixture obtained in step a3. at a temperature of approximately 90° C.

7. The process according to claim 5, in which the addition of fungal lactase in step b. is carried out at a temperature of approximately 45° C.

8. The process according to claim 5, in which the adjustment at step c. comprises the addition of powdered sugar.

9. The process according to claim 5, in which step d. is carried out before step b.

10. The process according to claim 5, in which step d. is carried out before step e.

11. The process according to claim 5, in which the drying step f. also comprises the step of:
f1. Making the third formulation by an operation selected from the group consisting of molding/demolding in molds of starch, the casting, the drying and the depowdering.

12. The process according to claim 5, further comprising the step of:
g. Storing the third formulation.
